(19) United States
(12) Patent Application Publication
(10) Pub. No.: US 2023/0368541 A1
(43) Pub. Date: Nov. 16, 2023

(54) OBJECT ATTENTION NETWORK

(71) Applicant: Ford Global Technologies, LLC, Dearborn, MI (US)

(72) Inventors: Daniel Goodman, Northville, MI (US); Sandhya Bhaskar, Sunnyvale, CA (US); Nikita Jaipuria, Union City, CA (US); Jinesh Jain, Pacifica, CA (US); Vidya Nariyambut Murali, Sunnyvale, CA (US)

(73) Assignee: Ford Global Technologies, LLC, Dearborn, MI (US)

(21) Appl. No.: 17/745,141

(22) Filed: May 16, 2022

(51) Int. Cl. G06V 20/58; G06V 20/40; G06V 10/82

(52) U.S. Cl. CPC G06V 20/58; G06V 20/41; G06V 10/82; G06V 20/46; B60W 60/0027

(57) ABSTRACT

A computer that includes a processor and a memory can predict future status of one or more moving objects by acquiring a plurality of video frames with a sensor included in a device, inputting the plurality of video frames to a first deep neural network to determine one or more objects included in the plurality of video frames, and inputting the objects to a second deep neural network to determine object features and full frame features. The computer can further input the object features and full frame features to a third deep neural network to determine spatial attention weights for the object features and full frame features, input the object features and full frame features to a fourth deep neural network to determine temporal attention weights for the object features and full frame features, and input the object features, full frame features, spatial attention weights and temporal attention weights to a fifth deep neural network to determine predictions regarding the one or more objects included the plurality of video frames.

### BACKGROUND

Images can be acquired by sensors and processed using a computer to determine data regarding objects in an environment around a system. Operation of a sensing system can include acquiring accurate and timely data regarding objects in the system's environment. A computer can acquire images from one or more image sensors that can be processed to determine data regarding objects. Data extracted from images of objects can be used by a computer to operate systems including vehicles, robots, security systems, and/or object tracking systems.

### BRIEF DESCRIPTION OF THE DRAWINGS

FIG. 1 is a block diagram of an example traffic infrastructure system.

FIG. 2 is a diagram of an example image of a traffic scene.

FIG. 3 is a diagram of an example image of a traffic scene including detected objects.

FIG. 4 is a diagram of an example convolutional neural network.

FIG. 5 is a diagram of an example recurrent neural network.

FIG. 6 is a diagram of an example object detection system.

FIG. 7 is a diagram of an example image of a traffic scene including detected objects.

FIG. 8 is a flowchart diagram of an example process to operate a vehicle based on detecting objects.

### DETAILED DESCRIPTION

As described herein, a DNN (deep neural network) executing on a computer in a vehicle may be used to locate objects in traffic and determine a vehicle path that avoids contact with the objects. Typically DNNs can identify and locate moving objects in a traffic scene but have difficulty in determining which moving objects might contact a vehicle and which moving object are not likely to contact the vehicle. Adding a recursive neural network (RNN) including attention mechanisms to the DNN can use a sequence of frames of video data to determine data regarding moving objects in the field of view of sensors included in the vehicle.

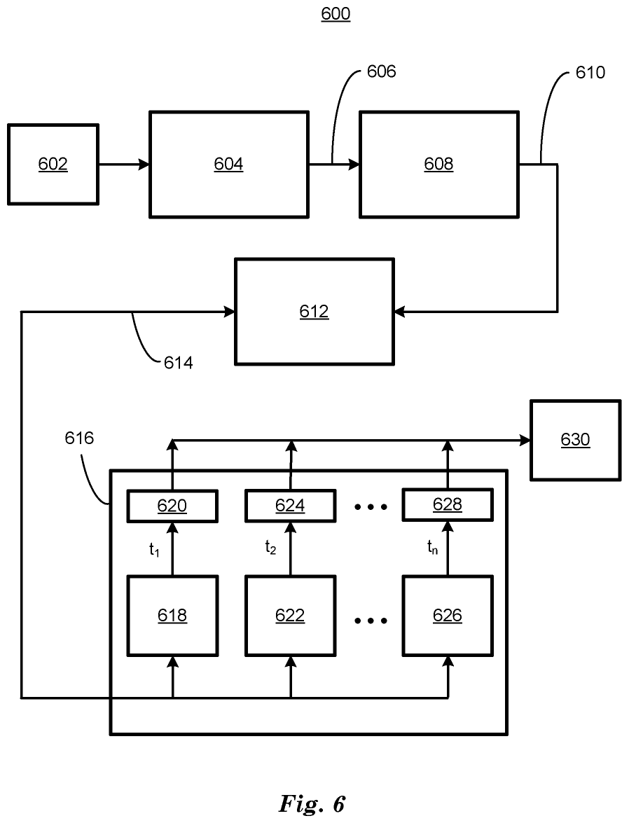

An attention mechanism is a DNN that is configured to learn which input elements are correlated with correct results, regardless of spatial distance between the elements. Attention mechanisms can input data as a first one-dimensional array with a second one-dimensional array of weights having the same number of elements at the first. During training all data elements that contribute to a correct answer will have their weights increased. At inference time weights learned during training are assigned to input data elements to indicate which data elements to process (i.e., “pay attention to”) in determining correct results. Adding an RNN and attention mechanisms can enhance determination of which moving objects are likely to contact a vehicle by including spatial and temporal data included in video stream data in addition to the moving vehicle itself. Examples of object features and full-frame features will be given below in relation to FIG. 6, below. The computer can control vehicle powertrain, steering and brakes to cause the vehicle to travel along a determined vehicle path and avoid the moving objects.

In addition to vehicle guidance, a sensing system can acquire data, for example image data, regarding an environment around the system and process the data to determine identities and/or locations of objects. For example, the DNN can be trained and then used to determine objects in image data acquired by sensors in systems including vehicle guidance, robot operation, security, manufacturing, and product tracking. Including attention mechanisms and RNNs can enhance determination of identities and/or locations of objects by processing spatial and temporal data from the entire scene around the object based on video stream data.

Vehicle guidance can include operation of vehicles in autonomous or semi-autonomous modes in environments that include a plurality of objects. Robot guidance can include guiding a robot end effector, for example a gripper, to pick up a part and orient the part for assembly in an environment that includes a plurality of parts. Security systems include features where a computer acquires video data from a camera observing a secure area to provide access to authorized users and detect unauthorized entry in an environment that includes a plurality of users. In a manufacturing system, the DNN can determine the location and orientation of one or more parts in an environment that includes a plurality of parts. In a product tracking system, a deep neural network can determine a location and orientation of one or more packages in an environment that includes a plurality of packages.

Vehicle guidance will be described herein as a non-limiting example of using a computer to detect objects, for example vehicles and pedestrians, in a traffic scene and determine a vehicle path for operating a vehicle based on the detected objects. A traffic scene is an environment around a traffic infrastructure system or a vehicle that can include a portion of a roadway and objects including vehicles and pedestrians, etc. For example, a computing device in a vehicle or traffic infrastructure system can be programmed to acquire one or more images from one or more sensors included in the vehicle or the traffic infrastructure system, detect objects in the images and communicate labels that identify the objects along with locations of the objects.

Advantageously, techniques discussed herein add attention mechanisms to the DNN/RNN process to determine which moving objects are likely to pose a threat to a vehicle, i.e., possibly contact the vehicle at a future time, and which moving objects do not pose a threat, i.e., not likely to contact the vehicle at a future time. Techniques discussed herein can determine where and when contact between a vehicle and moving objects can occur. Determining where and when contact between a vehicle and moving objects can occur permits the computer to determine a vehicle path that avoids contact with moving objects while ignoring moving objects that are not likely to contact the vehicle.

Disclosed herein is a method, including acquiring a plurality of video frames with a sensor included in a device, inputting the plurality of video frames to a first deep neural network to determine one or more objects included in the plurality of video frames and inputting the objects to a second deep neural network to determine object features and full frame features. The object features and the full frame features can be input to a third deep neural network to determine spatial attention weights for the object features and the full frame features and input to a fourth deep neural network to determine temporal attention weights for the object features and the full frame features. The object features, the full frame features, the spatial attention weights, and the temporal attention weights can be input to a fifth deep neural network to determine predictions regarding the one or more objects included the plurality of video frames. The predictions regarding the one or more objects can include probabilities that the device with contact one or more of the objects. The device can be a vehicle, and the vehicle can be operated based on the predictions regarding the one or more objects.

The first deep neural network and the second deep neural network can be convolutional neural networks that include a plurality of convolutional layers and a plurality of fully connected layers. The third deep neural network can be an attention-based neural network. The third deep neural network can output one-dimensional arrays that include the object features, the full frame features and the spatial attention weights. The fourth deep neural network can be an attention-based neural network. The fourth deep neural network can output one-dimensional arrays that include the object features, the full frame features and the temporal attention weights based on hidden variables input from the fifth deep neural network. The fifth deep neural network can be a recurrent neural network that includes a plurality of fully connected layers that transfer hidden variables to and from one or more memories. The first, second, third, fourth, and fifth deep neural networks can be trained by determining a loss function based on predictions regarding the one or more objects and ground truth regarding the one or more objects. The loss function can be backpropagated through the first, second, third, and fourth deep neural networks to determine parameter weights included in the first, second, third and fourth deep neural networks. The loss function can include a probability of contact for a frame of a video stream that includes a plurality of frames and contact at frame, acquired at a rate of f frames per second, a frame level exponential function and a Softmax cross entropy loss function. The predictions regarding the one or more objects can include outputting bounding boxes that include the objects. The ground truth can include a probability of contact with the one or more objects.

Further disclosed is a computer readable medium, storing program instructions for executing some or all of the above method steps. Further disclosed is a computer programmed for executing some or all of the above method steps, including a computer apparatus, programmed to acquire a plurality of video frames with a sensor included in a device, input the plurality of video frames to a first deep neural network to determine one or more objects included in the plurality of video frames and input the objects to a second deep neural network to determine object features and full frame features. The object features and the full frame features can be input to a third deep neural network to determine spatial attention weights for the object features and the full frame features and input to a fourth deep neural network to determine temporal attention weights for the object features and the full frame features. The object features, the full frame features, the spatial attention weights, and the temporal attention weights can be input to a fifth deep neural network to determine predictions regarding the one or more objects included the plurality of video frames. The predictions regarding the one or more objects can include probabilities that the device with contact one or more of the objects. The device can be a vehicle, and the vehicle can be operated based on the predictions regarding the one or more objects.

The instructions can include further instructions wherein the first deep neural network and the second deep neural network can be convolutional neural networks that include a plurality of convolutional layers and a plurality of fully connected layers. The third deep neural network can be an attention-based neural network. The third deep neural network can output one-dimensional arrays that include the object features, the full frame features, and the spatial attention weights. The fourth deep neural network can be an attention-based neural network. The fourth deep neural network can output one-dimensional arrays that include the object features, the full frame features and the temporal attention weights based on hidden variables input from the fifth deep neural network. The fifth deep neural network can be a recurrent neural network that includes a plurality of fully connected layers that transfer hidden variables to and from one or more memories. The first, second, third, fourth, and fifth deep neural networks can be trained by determining a loss function based on predictions regarding the one or more objects and ground truth regarding the one or more objects. The loss function can be backpropagated through the first, second, third, and fourth deep neural networks to determine parameter weights included in the first, second, third and fourth deep neural networks. The loss function can include a probability of contact for a frame of a video stream that includes a plurality of frames and contact at frame, acquired at a rate of f frames per second, a frame level exponential function and a Softmax cross entropy loss function. The predictions regarding the one or more objects can include outputting bounding boxes that include the objects. The ground truth can include a probability of contact with the one or more objects.

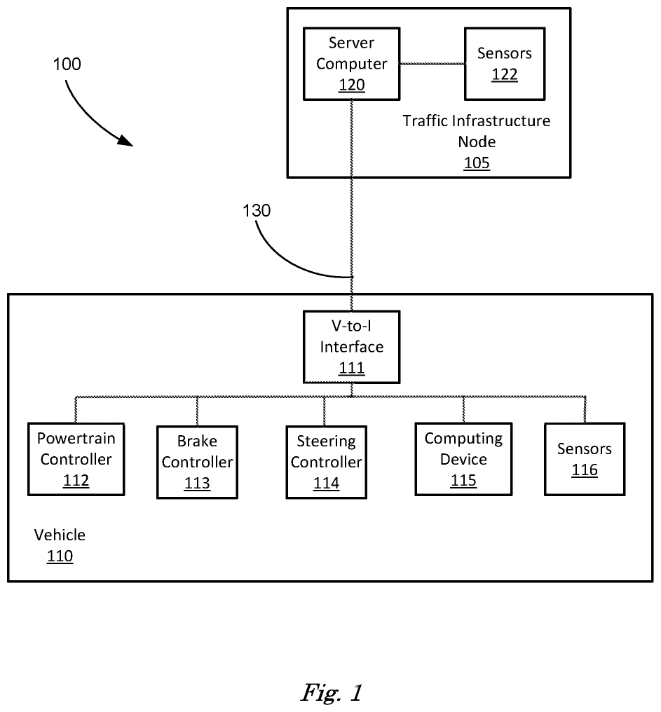

FIG. 1 is a diagram of a sensing system 100 that can include a traffic infrastructure node 105 that includes a server computer 120 and stationary sensors 122. Sensing system 100 includes a vehicle 110, operable in autonomous (“autonomous” by itself in this disclosure means “fully autonomous”), semi-autonomous, and occupant piloted (also referred to as non-autonomous) mode. One or more vehicle 110 computing devices 115 can receive data regarding the operation of the vehicle 110 from sensors 116. The computing device 115 may operate the vehicle 110 in an autonomous mode, a semi-autonomous mode, or a non-autonomous mode.

The computing device 115 includes a processor and a memory such as are known. Further, the memory includes one or more forms of computer-readable media, and stores instructions executable by the processor for performing various operations, including as disclosed herein. For example, the computing device 115 may include programming to operate one or more of vehicle brakes, propulsion (i.e., control of acceleration in the vehicle 110 by controlling one or more of an internal combustion engine, electric motor, hybrid engine, etc.), steering, climate control, interior and/or exterior lights, etc., as well as to determine whether and when the computing device 115, as opposed to a human operator, is to control such operations.

The computing device 115 may include or be communicatively coupled to, i.e., via a vehicle communications bus as described further below, more than one computing devices, i.e., controllers or the like included in the vehicle 110 for monitoring and/or controlling various vehicle components, i.e., a powertrain controller 112, a brake controller 113, a steering controller 114, etc. The computing device 115 is generally arranged for communications on a vehicle communication network, i.e., including a bus in the vehicle 110 such as a controller area network (CAN) or the like; the vehicle 110 network can additionally or alternatively include wired or wireless communication mechanisms such as are known, i.e., Ethernet or other communication protocols.

Via the vehicle network, the computing device 115 may transmit messages to various devices in the vehicle and/or receive messages from the various devices, i.e., controllers, actuators, sensors, etc., including sensors 116. Alternatively, or additionally, in cases where the computing device 115 actually comprises multiple devices, the vehicle communication network may be used for communications between devices represented as the computing device 115 in this disclosure. Further, as mentioned below, various controllers or sensing elements such as sensors 116 may provide data to the computing device 115 via the vehicle communication network.

In addition, the computing device 115 may be configured for communicating through a vehicle-to-infrastructure (V-to-I) interface 111 with a remote server computer 120, i.e., a cloud server, via a network 130, which, as described below, includes hardware, firmware, and software that permits computing device 115 to communicate with a remote server computer 120 via a network 130 such as wireless Internet (WI-FI®) or cellular networks. V-to-I interface 111 may accordingly include processors, memory, transceivers, etc., configured to utilize various wired and/or wireless networking technologies, i.e., cellular, BLUETOOTH® and wired and/or wireless packet networks. Computing device 115 may be configured for communicating with other vehicles 110 through V-to-I interface 111 using vehicle-to-vehicle (V-to-V) networks, i.e., according to Dedicated Short Range Communications (DSRC) and/or the like, i.e., formed on an ad hoc basis among nearby vehicles 110 or formed through infrastructure-based networks. The computing device 115 also includes nonvolatile memory such as is known. Computing device 115 can log data by storing the data in nonvolatile memory for later retrieval and transmittal via the vehicle communication network and a vehicle to infrastructure (V-to-I) interface 111 to a server computer 120 or user mobile device 160.

As already mentioned, generally included in instructions stored in the memory and executable by the processor of the computing device 115 is programming for operating one or more vehicle 110 components, i.e., braking, steering, propulsion, etc., without intervention of a human operator. Using data received in the computing device 115, i.e., the sensor data from the sensors 116, the server computer 120, etc., the computing device 115 may make various determinations and/or control various vehicle 110 components and/or operations without a driver to operate the vehicle 110. For example, the computing device 115 may include programming to regulate vehicle 110 operational behaviors (i.e., physical manifestations of vehicle 110 operation) such as speed, acceleration, deceleration, steering, etc., as well as tactical behaviors (i.e., control of operational behaviors typically in a manner intended to achieve efficient traversal of a route) such as a distance between vehicles and/or amount of time between vehicles, lane-change, minimum gap between vehicles, left-turn-across-path minimum, time-to-arrival at a particular location and intersection (without signal) minimum time-to-arrival to cross the intersection.

Controllers, as that term is used herein, include computing devices that typically are programmed to monitor and/or control a specific vehicle subsystem. Examples include a powertrain controller 112, a brake controller 113, and a steering controller 114. A controller may be an electronic control unit (ECU) such as is known, possibly including additional programming as described herein. The controllers may communicatively be connected to and receive instructions from the computing device 115 to actuate the subsystem according to the instructions. For example, the brake controller 113 may receive instructions from the computing device 115 to operate the brakes of the vehicle 110.

The one or more controllers 112, 113, 114 for the vehicle 110 may include known electronic control units (ECUs) or the like including, as non-limiting examples, one or more powertrain controllers 112, one or more brake controllers 113, and one or more steering controllers 114. Each of the controllers 112, 113, 114 may include respective processors and memories and one or more actuators. The controllers 112, 113, 114 may be programmed and connected to a vehicle 110 communications bus, such as a controller area network (CAN) bus or local interconnect network (LIN) bus, to receive instructions from the computing device 115 and control actuators based on the instructions.

Sensors 116 may include a variety of devices known to provide data via the vehicle communications bus. For example, a radar fixed to a front bumper (not shown) of the vehicle 110 may provide a distance from the vehicle 110 to a next vehicle in front of the vehicle 110, or a global positioning system (GPS) sensor disposed in the vehicle 110 may provide geographical coordinates of the vehicle 110. The distance(s) provided by the radar and/or other sensors 116 and/or the geographical coordinates provided by the GPS sensor may be used by the computing device 115 to operate the vehicle 110 autonomously or semi-autonomously, for example.

The vehicle 110 is generally a land-based vehicle 110 capable of autonomous and/or semi-autonomous operation and having three or more wheels, i.e., a passenger car, light truck, etc. The vehicle 110 includes one or more sensors 116, the V-to-I interface 111, the computing device 115 and one or more controllers 112, 113, 114. The sensors 116 may collect data related to the vehicle 110 and the environment in which the vehicle 110 is operating. By way of example, and not limitation, sensors 116 may include, i.e., altimeters, cameras, LIDAR, radar, ultrasonic sensors, infrared sensors, pressure sensors, accelerometers, gyroscopes, temperature sensors, pressure sensors, hall sensors, optical sensors, voltage sensors, current sensors, mechanical sensors such as switches, etc. The sensors 116 may be used to sense the environment in which the vehicle 110 is operating, i.e., sensors 116 can detect phenomena such as weather conditions (precipitation, external ambient temperature, etc.), the grade of a road, the location of a road (i.e., using road edges, lane markings, etc.), or locations of target objects such as neighboring vehicles 110. The sensors 116 may further be used to collect data including dynamic vehicle 110 data related to operations of the vehicle 110 such as velocity, yaw rate, steering angle, engine speed, brake pressure, oil pressure, the power level applied to controllers 112, 113, 114 in the vehicle 110, connectivity between components, and accurate and timely performance of components of the vehicle 110.

Vehicles can be equipped to operate in both autonomous and occupant piloted mode. By a semi- or fully-autonomous mode, we mean a mode of operation wherein a vehicle can be piloted partly or entirely by a computing device as part of a system having sensors and controllers. The vehicle can be occupied or unoccupied, but in either case the vehicle can be partly or completely piloted without assistance of an occupant. For purposes of this disclosure, an autonomous mode is defined as one in which each of vehicle propulsion (i.e., via a powertrain including an internal combustion engine and/or electric motor), braking, and steering are controlled by one or more vehicle computers; in a semi-autonomous mode the vehicle computer(s) control(s) one or more of vehicle propulsion, braking, and steering. In a non-autonomous mode, none of these are controlled by a computer.

A traffic infrastructure node 105 can include a physical structure such as a tower or other support structure (i.e., a pole, a box mountable to a bridge support, cell phone tower, road sign support, etc.) on which infrastructure sensors 122, as well as server computer 120 can be mounted, stored, and/or contained, and powered, etc. One traffic infrastructure node 105 is shown in FIG. 1 for ease of illustration, but the system 100 could and likely would include tens, hundreds, or thousands of traffic infrastructure nodes 105. The traffic infrastructure node 105 is typically stationary, i.e., fixed to and not able to move from a specific geographic location. The infrastructure sensors 122 may include one or more sensors such as described above for the vehicle 110 sensors 116, i.e., lidar, radar, cameras, ultrasonic sensors, etc. The infrastructure sensors 122 are fixed or stationary. That is, each sensor 122 is mounted to the infrastructure node so as to have a substantially unmoving and unchanging field of view.

Server computer 120 typically has features in common with the vehicle 110 V-to-I interface 111 and computing device 115, and therefore will not be described further to avoid redundancy. Although not shown for ease of illustration, the traffic infrastructure node 105 also includes a power source such as a battery, solar power cells, and/or a connection to a power grid. A traffic infrastructure node 105 server computer 120 and/or vehicle 110 computing device 115 can receive sensor 116, 122 data to monitor one or more objects. An “object,” in the context of this disclosure, is a physical, i.e., material, structure detected by a vehicle sensor 116 and/or infrastructure sensor 122. An object may be a biological object such as a human. A server computer 120 and/or computing device 115 can perform biometric analysis on object data acquired by a sensor 116/122.

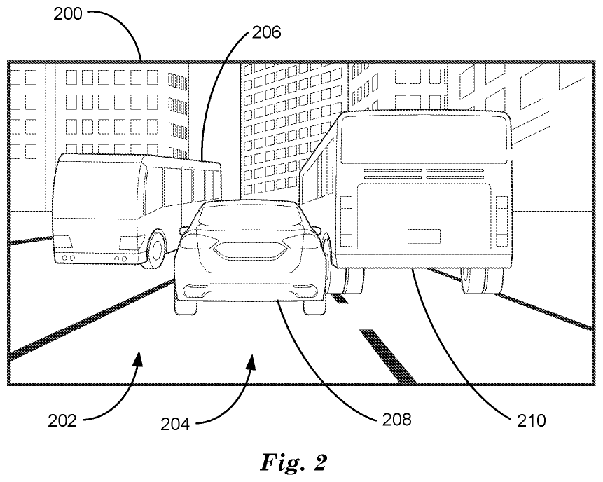

FIG. 2 is a diagram of an image 200 of a traffic scene 202. Traffic scene 202 includes a roadway 204 and three objects 206, 208, 210. Image 200 can be a frame of video stream data acquired by a sensor 116 included in a vehicle 110. The sensor 116 can be a video camera, for example. In traffic scene 202, object 206 can be a bus traveling in an adjacent lane of oncoming traffic and objects 208, 210 can be a car and a bus, respectively traveling in traffic lanes headed in the same direction as vehicle 110.

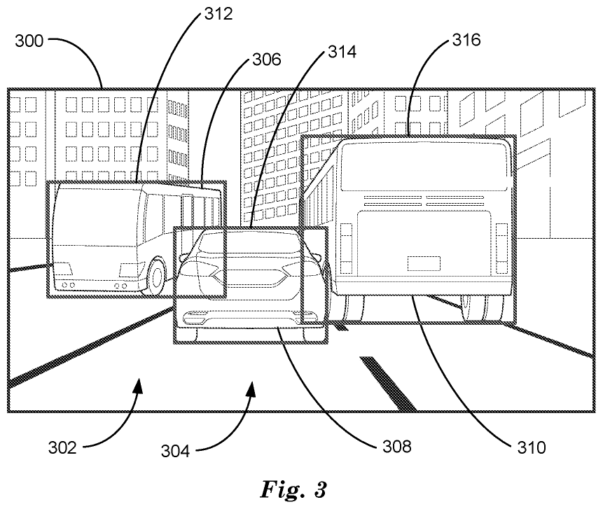

FIG. 3 is a diagram of an image 300 of a traffic scene 302. Traffic scene 302 includes a roadway 304 and three objects 306, 308, 310. In this example objects 306, 308, 310 can be a bus, a car and another bus, respectively. Image 300 can be a frame of video data acquired by a video camera included in a vehicle 110. Image 300 has been processed by a DNN to determine bounding boxes 312, 314, 316 around objects 306, 308, 310, respectively. The DNN correctly determines that objects 306, 308, 310 are moving objects in traffic scene 302 but fail to determine that object 306 is at a location and moving in a direction such that a probability that object 306 will contact vehicle 110 is very low. Because of this, object 306 does not pose a threat to vehicle 110 and for this reason should not be included in vehicle path planning for vehicle 110.

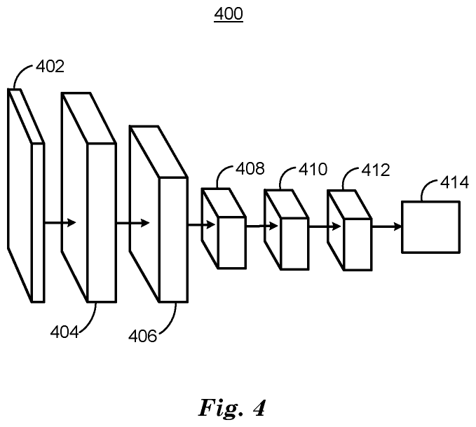

FIG. 4 is a diagram of a convolutional neural network (CNN) 400. A CNN 400 is a DNN configured to input an image 402 and output predictions 414 regarding the input image 402. CNN 400 can include a plurality of convolutional layers 404, 406, 408 and a plurality of fully connected layers 410, 412. Convolutional layers 404, 406, 408 each convolve the input data using programmable convolution kernels and typically reduce the resolution of the results by determining one value out of a neighborhood of adjacent result values to pass onto the next layer. For example, a convolutional layer 404, 406, 408 can use max pooling to select the maximum value in a 2×2 neighborhood of pixels resulting from convolving the input image with one or more convolution kernels.

The fully connected layers 410, 412 of CNN 400 input latent variables output from the convolutional layers 404, 406, 408 and determine output predictions 414 based on the latent variables. Fully connected layers 410, 412 determine programmable linear or non-linear functions of the input variables to determine output predictions 414. In the first DNN 604 from FIG. 6, the output predictions 414 are object locations and labels. In the second DNN 608 from FIG. 6, the output predictions 414 are object and full frame features.

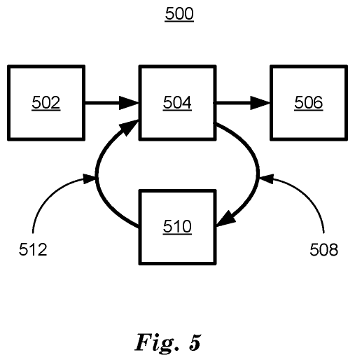

FIG. 5 is a diagram of a recurrent neural network (RNN) 500. RNN 500 includes a DNN 504 that inputs data 502, which can be object features in this example. RNN 500 includes a memory 510 that inputs hidden variables from DNN 504. RNN 500 can input a plurality of frames of data 502, for example, including object features included in a sequence of frames from a video stream. As data 502 from each frame from a video stream is processed by DNN 504, hidden variables 508 indicating a state of DNN 504 and processing results are output to memory 510. At the same time, hidden variables 512 from previous data 502 processed by DNN 504 can be output by memory 510 to be processed along with current data 502. For each input frame of data 502, DNN 504 can output predictions 506 based on current data 502 and previously processed data 502. RNN 500 can be trained using loss functions as described in equation (1), below to determine weights to be applied to the DNN 504 based on comparing ground truth to output predictions 506. Ground truth is data regarding one or more objects included video stream data included in training datasets. Ground truth can be determined by users viewing the video stream data and annotating the video stream data with descriptions of possible contact between objects in the video stream data and vehicles 110 acquiring the video stream data.

FIG. 6 is a diagram of an object detection system 600. Object detection system 600 inputs frames 602 of video stream data acquired by a sensor 116 included in a vehicle 110 into a first deep neural network (DNN) 604. First DNN 604 inputs a frame 602 of video stream data and outputs detected objects 606 in the frame 602. Detecting objects 606 means determining a object labels and locations. Object labels can include “vehicle”, “bus”, “truck”, “pedestrian”, and other types of objects typically found in traffic scenes 202, 302. Object locations can be determined in pixel coordinates determined relative to a frame 602 of video stream data, or real-world global coordinates determined relative to a vehicle 110. First DNN 604 can be a convolutional neural network (CNN) as described in relation to FIG. 5.

The detected objects 606 output from first DNN 604 and the input frame 602 of video data are input to a second DNN 608 that extracts features 610 from the detected objects output from the first DNN 604 and the frame 602 of video data. Features 610 include object features and full frame features. Object features are physical attributes of objects that can be determined by performing image processing operations on the image data that includes the object. For example, object features can include object height and width, and object orientation. Other object features can include portions of an object that can be determined by image processing techniques. For example, object features applied to vehicles can include wheels, lights, windows, etc. Full frame features can include locations and/or labels for roadway edges, traffic lanes, traffic signals and traffic signs. Second DNN 604 can also be a CNN as described in relation to FIG. 5.

Features 610 including object feature and full frame features are output to dynamic spatial channel 612, which includes two DNNs including attention mechanisms to determine to determine predictions regarding object and full frame features based on spatial and temporal properties of the object features and full frame features. The spatial DNN determines predictions regarding object features and full frame features by determining weights based on spatial relationships between the object features and full frame features. For example, object features included in a vehicle receive increase or decrease weights depending upon where the features occur in in an image with respect to full frame features. For example, if object features occur between lane markers that indicate the object features are in the same traffic lane as the vehicle 110 acquiring the image, weights included in the object features can be increased. Increasing weights included in an object feature increases a probability that the spatial DNN will output a prediction that indicates contact can occur between objects that include the object features and the vehicle 110.

The dynamic spatial channel also includes a temporal/spatial DNN that determines predictions regarding object features and full frame features based on spatial and temporal properties of the object features and the full frame features. The temporal/spatial DNN received input from hidden variables output from DSA-RNN 616 that are based on processing a plurality of frames of video stream data. The hidden variables output from DSA-RNN indicate temporal properties of the object features and full frame features. Temporal properties can include direction and speed of object features, for example. The temporal properties of object features can be combined with full frame features to increase or decrease weights included in the object features.

For example, if full frame features indicate that object features are located in an adjacent lane of traffic and temporal features indicate that the object features are moving away from the vehicle 110, weights included in the object features would be decreased to decrease the probability that a prediction would be output that indicates contact between an object which includes the object features and the vehicle 110. In other examples where spatial properties of the object features indicate that they are located in the same traffic lane as the vehicle and temporal properties of the object features indicate that the object features are stopped, weights included in the object feature can be increased to increase the probability that a prediction can be output that indicates possible contact between an object which includes the object features and the vehicle 110.

The spatial DNN and temporal/spatial DNN included in dynamic spatial channel 612 output predictions regarding objects based on the probability that the features are included in a video stream that include contact between an object 306, 308, 310 and the vehicle 110. For example, dynamic spatial channel 612 will weight features included in objects 308, 310 indicated by bounding boxes 314, 316 as having a high probability of contact because they are in the same traffic lane as the vehicle 110 that acquired the frame 602 of video stream data. The object 306 indicated by bounding box 312 will be weighted as having a low probability of contact with vehicle 110 because the object 306 indicated by bounding box 312 is in an oncoming traffic lane and is oriented in a direction that takes it away from the vehicle 110.

The spatial DNN and temporal/spatial DNN included in dynamic spatial channel 612 uses spatial attention on full frame features to obtain contextual information associated with a traffic scene 302. This enables dynamic spatial channel 612 to determine weight data in addition to the objects and learn to attend to more abstract concepts, for example dynamic relationships between object feature and full frame features. Determining weight data based on object features and full frame features over time assigns weights to the detected objects. In addition to enabling accurate localization, we also observe that using dynamic spatial channel 612 enhances anticipation of contact between objects 308, 310 and the vehicle 110. Using dynamic spatial channel 612 can alleviate undesirable and harmful propagation of incorrect detections of objects to downstream tasks such as determining vehicle paths.

Object features and full frame feature predictions 614 are output from dynamic spatial channel 612 to dynamic spatial architecture-recurrent neural network (DSA-RNN) 616. DSA-RNN 616 includes an RNN 500 as discussed in relation to FIG. 5. FIG. 5 includes three renderings of input object features and full frame feature predictions 618, 622, 626 at three time steps, t₁, t₂, and tₙ, as they are input to RNNs 620, 624, 628 at three time steps to illustrate the dynamic aspects of inputting object features and full frame feature predictions 618, 622, 626 from a sequence of frames 602 of video stream data. RNNs 620, 624, 628 includes memory that can track object features and full frame feature predictions 618, 622, 626 over time to determine a probability of contact between objects that include the object features with vehicle 110. For example, speed and direction of objects indicated by bounding boxes 314, 316 can be tracked by DSA-RNN 616 to determine a probability of contact with vehicle 110. DSA-RNN 616 outputs predictions 630 that include objects and probabilities of contact with vehicle 110. DSA-RNN 616 is discussed in relation FIG. 6.

Output predictions 630 from DSA-RNN 616 are output to computing device 115 to determine a vehicle path for vehicle 110. For example, if objects indicated by bounding boxes 314, 316 are traveling at the same speed and direction as vehicle 110, no action may be indicated. If output predictions 630 from DSA-RNN 616 indicates that one or more of objects indicated by bounding boxes 314, 316 is stopped, for example, computing device 115 can determine a vehicle path that includes either stopping vehicle 110 or determining a vehicle path that avoids the stopped object. Computing device 115 can then transmit commands to controllers 112, 113, 114 to either stop vehicle 110 or direct vehicle 110 travel on a vehicle path that avoids the stopped object.

Object detection system 600 can be trained to determine which objects in a traffic scene are most likely to involved in contact with a vehicle 110. Determining a vehicle path for a vehicle 110 operating in a traffic scene 202 can be a complex and challenging task. Object detection system 600 enhances the ability of a computing device 115 to determine a vehicle path that avoids contact with objects 206, 208, 210 in a traffic scene 202 by determining which objects 208, 210 have a high probability of contact with a vehicle 110 and which objects 206 have a low probability of contact. Computing device 115 can determine a vehicle path based on objects 208, 210 have a high probability of contact while ignoring objects 206 having a low probability of contact. Determining vehicle paths based on output from object detection system 600 can use fewer computing resources and determine results in less time than determining vehicle paths based on all detected objects indicated by bounding boxes 312, 314, 316 in a traffic scene 302.

Object detection system 600 can be trained using training datasets of video stream data of traffic scenes 202. The training datasets include ground truth data regarding contact or near contact with objects 206, 208, 210 in the traffic scene 202. For example, a positive video stream includes contact or near contact between an object 206, 208, 210 and a vehicle 110 and a negative video stream does not include contact or near contact between an object 206, 208, 210 and a vehicle 110. Near contact can be set to a suitable value for a situation of the vehicle, e.g., based on the speed of vehicle 110. At low speeds, for example speeds of the vehicle expected during parking, e.g., less than 5 miles per hour, 10 centimeters can be regarded as near contact. At traveling speeds (e.g., five miles per hour or higher) one meter can be regarded as near contact. “Low” and “traveling” speeds can be determined based on empirical testing and or simulations that indicate the ability of computing device 115 to control the motion of vehicle 110 to avoid contact at various speeds.

During training, a sample video stream is processed a plurality of times and at each processing step the output predictions 630 from the object detection system 600 are compared to the ground truth data. The comparison between the output predictions 630 and ground truth is used to determine a loss function. An exponential loss and Softmax cross entropy loss function is used to determine how close the output predictions 630 are to the ground truth. Given an output prediction 630 that includes a probability of contact a_{t,v} for frame t of a video stream v that includes T frames and contact at frame τ, acquired at a rate of f frames per second, a frame level exponential and Softmax cross entropy loss function [symbol] can be defined by the equation:

$${ℒ}_{ℱ} = {\sum }_{v = 1}^{V} [ - {l}_{v} {\sum }_{t = 1}^{T} {e}^{- max ( \frac{τ - t}{f} , 0 )} log ( {a}_{t , v} ) - ( 1 - {l}_{v} ) {\sum }_{t = 1}^{T} log ( 1 - {a}_{t , v} ) ] , \qquad ( 1 )$$

where the first term within the square bracket is the exponential loss for a positive video and the second term is the Softmax cross entropy loss for a negative video.

The loss function is backpropagated through the DNNs and RNNs included in the object detection system 600. Backpropagation means applying the loss function to the layers of the deep neural networks starting at the layers closest to the output of the deep neural network and applying the loss function to the layers in turn until the layers closest to the input is reached. Applying the loss function includes selecting parameter weights that direct the operation of the layers based on minimizing the loss function over a plurality of trials which employ a plurality of different parameter weights. The parameter weights that result in the minimal loss function are selected.

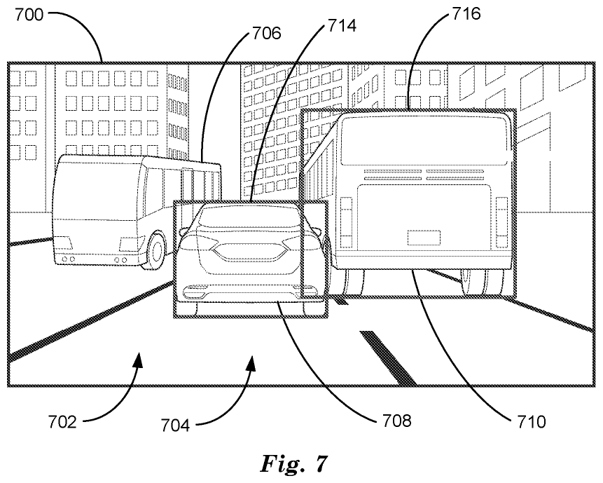

FIG. 7 is a diagram of an image 700 of a traffic scene 702. Image 700 of traffic scene 702 can be a frame of video stream data acquired by a sensor 116 in a vehicle 110 traveling on roadway 704. Traffic scene 702 includes objects 706, 708, 710. The object 706 is a bus traveling in a lane of oncoming traffic in roadway 704, and objects 708, 710 include a vehicle and a bus traveling in traffic lanes headed in the same direction as vehicle 110. Based on inputting a plurality of frames of video stream data acquired over a time period that can be one or more seconds to object detection system 600 as described in relation to FIGS. 4-6, above, object detections system 600 outputs bounding boxes 714, 716 indicating that objects 708, 710 have a high probability of contacting vehicle 110 at a future time. Object 706 does not have a bounding box because object detection system 600 has determined that object 706 has a low probability of contacting vehicle 110 based on the location of object 110 with respect to full frame objects included in image 700, and the speed and direction of object 706. Reducing the number of detected objects based on full frame features and speed and direction of the objects permits computing device 115 to determine a vehicle path for vehicle 110 using fewer computing resources and less time than object detection systems that detect all objects in an image 700.

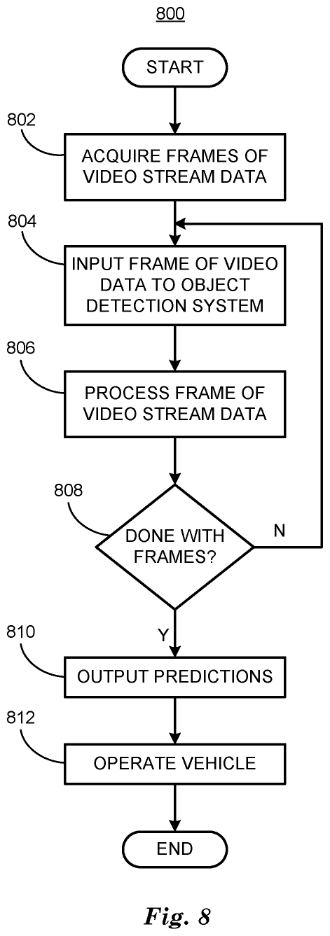

FIG. 8 is a flowchart, described in relation to FIGS. 1-7 of a process 800 for determining objects with high probability of contact with a vehicle 110. Process 800 can be implemented by a processor of a computing device 115, taking as input frames 602 of input video stream data from sensors 116, executing commands, and outputting object predictions 630. Process 800 includes multiple blocks that can be executed in the illustrated order. Process 800 could alternatively or additionally include fewer blocks or can include the blocks executed in different orders.

Process 800 begins at block 802, where a plurality of frames 602 of video stream data are acquired as images. The frames of video stream data can be acquired by a sensor 116, for example a video camera, included in a vehicle 110 operating on a roadway 704 in a traffic scene 702.

At block 804 a frame of video stream data is input as frame 602 of video stream data to object detection system 600 to determine objects 708, 710 that have a high probability of contacting vehicle 110.

At block 806 the object detection system 600 processes the current frame 602 of video stream data as discussed above in relation to FIG. 6.

At block 808 process 800 checks to see if the last frame of video stream data has been processed by object detection system 600. If the last frame has not been processed, process 800 returns to block 804 to input the next frame of video stream data. If the last frame has been processed, process 800 passes to block 810.

At block 810 predictions including bounding boxes 714, 716 and probabilities that objects 708, 710 might contact vehicle 110 are output to computing device 115.

At block 812 computing device 115 determines a vehicle path for vehicle 110 that avoids contact with objects 708, 710. Computing device 115 can then control one or more of vehicle powertrain, vehicle brakes and vehicle steering to direct vehicle on the determined vehicle path to avoid contact with objects 708, 710. Following block 812 process 800 ends,

Computing devices such as those discussed herein generally each includes commands executable by one or more computing devices such as those identified above, and for carrying out blocks or steps of processes described above. For example, process blocks discussed above may be embodied as computer-executable commands.

Computer-executable commands may be compiled or interpreted from computer programs created using a variety of programming languages and/or technologies, including, without limitation, and either alone or in combination, Java™, C, C++, Python, Julia, SCALA, Visual Basic, Java Script, Perl, HTML, etc. In general, a processor (i.e., a microprocessor) receives commands, i.e., from a memory, a computer-readable medium, etc., and executes these commands, thereby performing one or more processes, including one or more of the processes described herein. Such commands and other data may be stored in files and transmitted using a variety of computer-readable media. A file in a computing device is generally a collection of data stored on a computer readable medium, such as a storage medium, a random access memory, etc.

A computer-readable medium (also referred to as a processor-readable medium) includes any non-transitory (i.e., tangible) medium that participates in providing data (i.e., instructions) that may be read by a computer (i.e., by a processor of a computer). Such a medium may take many forms, including, but not limited to, non-volatile media and volatile media. Instructions may be transmitted by one or more transmission media, including fiber optics, wires, wireless communication, including the internals that comprise a system bus coupled to a processor of a computer. Common forms of computer-readable media include, for example, RAM, a PROM, an EPROM, a FLASH-EEPROM, any other memory chip or cartridge, or any other medium from which a computer can read.

All terms used in the claims are intended to be given their plain and ordinary meanings as understood by those skilled in the art unless an explicit indication to the contrary in made herein. In particular, use of the singular articles such as “a,” “the,” “said,” etc. should be read to recite one or more of the indicated elements unless a claim recites an explicit limitation to the contrary.

The term “exemplary” is used herein in the sense of signifying an example, i.e., a reference to an “exemplary widget” should be read as simply referring to an example of a widget.

The adverb “approximately” modifying a value or result means that a shape, structure, measurement, value, determination, calculation, etc. may deviate from an exactly described geometry, distance, measurement, value, determination, calculation, etc., because of imperfections in materials, machining, manufacturing, sensor measurements, computations, processing time, communications time, etc.

In the drawings, the same reference numbers indicate the same elements. Further, some or all of these elements could be changed. With regard to the media, processes, systems, methods, etc. described herein, it should be understood that, although the steps or blocks of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain embodiments, and should in no way be construed so as to limit the claimed invention.

1. A system, comprising:
a computer that includes a processor and a memory, the memory including instructions executable by the processor to predict future status of one or more moving objects by:
acquiring a plurality of video frames with a sensor included in a device;
inputting the plurality of video frames to a first deep neural network to determine one or more objects included in the plurality of video frames;
inputting the one or more objects to a second deep neural network to determine object features and full frame features;
inputting the object features and the full frame features to a third deep neural network to determine spatial attention weights for the object features and the full frame features;
inputting the object features and the full frame features to a fourth deep neural network to determine temporal attention weights for the object features and the full frame features; and
inputting the object features, the full frame features, the spatial attention weights, and the temporal attention weights to a fifth deep neural network to determine predictions regarding the one or more objects included the plurality of video frames.

2. The system of claim 1, wherein the predictions regarding the one or more objects includes probabilities that the device with contact one or more of the objects.

3. The system of claim 1, wherein the device is a vehicle, and the instructions include further instructions to operate the vehicle based on the predictions regarding the one or more objects.

4. The system of claim 1, wherein the first deep neural network and the second deep neural network are convolutional neural networks that include a plurality of convolutional layers and a plurality of fully connected layers.

5. The system of claim 1, wherein the third deep neural network is an attention-based neural network.

6. The system of claim 5, wherein the third deep neural network outputs one-dimensional arrays that include the object features, the full frame features and the spatial attention weights.

7. The system of claim 1, wherein the fourth deep neural network is an attention-based neural network.

8. The system of claim 7, wherein the fourth deep neural network outputs one-dimensional arrays that include the object features, the full frame features and the temporal attention weights based on hidden variables input from the fifth deep neural network.

9. The system of claim 1, wherein the fifth deep neural network is a recurrent neural network that includes a plurality of fully connected layers that transfer hidden variables to and from one or more memories.

10. The system of claim 1, wherein the first, second, third, fourth, and fifth deep neural networks are trained by determining a loss function based on predictions regarding the one or more objects and ground truth regarding the one or more objects.

11. The system of claim 10, wherein the loss function is backpropagated through the first, second, third, and fourth deep neural networks to determine parameter weights included in the first, second, third and fourth deep neural networks.

12. A method, comprising:
acquiring a plurality of video frames with a sensor included in a device;
inputting the plurality of video frames to a first deep neural network to determine one or more objects included in the plurality of video frames;
inputting the objects to a second deep neural network to determine object features and full frame features;
inputting the object features and the full frame features to a third deep neural network to determine spatial attention weights for the object features and the full frame features;
inputting the object features and the full frame features to a fourth deep neural network to determine temporal attention weights for the object features and the full frame features; and
inputting the object features, the full frame features, the spatial attention weights, and the temporal attention weights to a fifth deep neural network to determine predictions regarding the one or more objects included the plurality of video frames.

13. The method of claim 12, wherein the predictions regarding the one or more objects includes probabilities that the device with contact one or more of the objects.

14. The method of claim 12, wherein the device is a vehicle, and the vehicle is operated based on the predictions regarding the one or more objects.

15. The method of claim 12, wherein the first deep neural network and the second deep neural network are convolutional neural networks that include a plurality of convolutional layers and a plurality of fully connected layers.

16. The method of claim 12, wherein the third deep neural network is an attention-based neural network.

17. The method of claim 16, wherein the third deep neural network outputs one-dimensional arrays that include the object features, the full frame features and the spatial attention weights.

18. The method of claim 12, wherein the fourth deep neural network is an attention-based neural network.

19. The method of claim 18, wherein the fourth deep neural network outputs one-dimensional arrays that include the object features, the full frame features and the temporal attention weights based on hidden variables input from the fifth deep neural network.

20. The method of claim 12 wherein the fifth deep neural network is a recurrent neural network that includes a plurality of fully connected layers that transfer hidden variables to and from one or more memories.
